(19) United States
(12) Patent Application Publication
(10) Pub. No.: US 2012/0131825 A1
(43) Pub. Date: May 31, 2012

(54) GREETINGS CARDS

(76) Inventor: James Hoy, Surrey (GB)

(21) Appl. No.: 12/956,199

(22) Filed: Nov. 30, 2010

(51) Int. Cl. G09F 1/06; G03B 25/02

(52) U.S. Cl. 40/124.14

(57) ABSTRACT

The present invention provides greetings card or similar flat pack folding sheet self-supporting display article that comprises: at least one sheet that is flat in an initial state but when folded to its operational configuration defines a rocking base that has a platform or summit supported by at least one rocker and the article having an upstanding card portion or panel serving as a display panel bearing text or graphic images that extends upright through the platform or summit.

### FIELD OF THE INVENTION

The present invention concerns improvements in and relating to greetings cards and similar folding sheet self-supporting table-top display articles that when folded to their operational state have an upstanding card portion serving as a display bearing text or graphic images. These articles are suitably of a sheet of rigid foldable material, such as card or foldable sheet plastics or card that is plastics-laminated, and in use are folded into a self-supporting standing configuration. They may be greetings cards or table-top place marker cards or menus or may serve as advertising premiums/promotional articles, point of sale displays and information providers, toys or collectibles—eg collectible character cards—or even simply serve as decorations for shelves, table-tops or other such planar surfaces.

### BACKGROUND TO THE INVENTION

Greetings cards or other folding card articles of the type in question are by their nature generally styled to be interesting and eye-catching.

In the UK alone the greetings card industry, estimated to have annual turn-over above one billion pounds sterling, invests many millions of pounds every year in trying to develop ever more eye-catching innovative designs.

Over the years a number of different approaches have been adopted to stimulate the interest of purchasers and recipients of greetings cards. These range from simple techniques such as decoupage, layering the card to give it a three dimensional quality and providing kits for DIY card construction in which a variety of different user-selectable labels or cut-outs may be mounted to the card. A significant high-tech trend in recent years is designing the cards to have an inter-active element such as a pre-recorded or recordable message voice-synthesis chip to read out the greeting or play a tune when the greetings card is opened. In other developments a moving graphic element or pop-up element is built into the card construction. Some cards even combine audio and video media as, for example, shown in US 2007171278 where the card carries a chip with multimedia storage and the card has both a speaker and a video display screen.

One area of visually inter-active design that is proving increasingly popular is the area of lenticular or holographic cards. In the lenticular cards a lenticular plastics sheet is laminated over the portion of card bearing the images. These have two or more interlaced images that are selectively viewable through the lenticular layer. They can give a three dimensional effect to an image, provide a transforming/morphing image or provide a much more cost-effective way of displaying moving images on a greetings card than the use of a chip and display screen. They generally rely on the user simply holding and adjusting the poise of the card relative to their own line of sight to give the impression of an animated image.

A sophisticated example of such a lenticular folding card is described and illustrated in U.S. Pat. No. 6,843,009. Here the folding card has hinged front and back flaps, the front flap has the lenticular sheet spaced from it as a sleeve that slidingly receives the portion of the card bearing the image, the image bearing portion being shaped as a tab attached at one end to the back flap whereby the user is able to animate the image on the card during opening of the card as the rear flap opens pulling the image-bearing portion of the card beneath the lenticular sheet.

### SUMMARY OF THE INVENTION

According to the present invention there is provided a greetings card other flat pack folding sheet self-supporting display article that comprises: at least one sheet that is flat in an initial state but when folded to its operational configuration defines a rocking base that has a base portion supported by at least one rocker and the article having an upstanding card portion or panel serving as a display panel bearing text or graphic images that extends upright from the rocker-supported base portion and wherein the rocker-supported base portion of the rocking base has an aperture therein through which the upstanding display panel is projected and extends upwardly.

The base portion may be formed by bending/bowing a part of the sheet into an arcuate/rocker form and securing it in that form but preferably the arcuate/rocker forms are pre-formed, suitably of plastics, and the base is folded/bent into a bridge shaped operational configuration to bring the arcuate/rocker forms into ground/table-top engaging arrangement. In this erected state the panels defining the arcuate/rocker forms are substantially plane parallel and substantially vertical (substantially perpendicular to the platform and to the table-top or other support surface on which the article is stood to be rocked).

The greetings card or similar display article suitably further comprises a lenticular layer covering the image-bearing part of the upstanding card portion or the image is a hologram, whereby when the card/article is induced to rock back and forth on its arcuate base portion the image will change, for example appearing to be animated.

By this simple but unique arrangement a greetings card or similar display article may be formed solely from a flat plastics, plastics-laminated card sheet or card and folded to provide an animated image, the image moving without need for the user to hold the device in different poises or even to mount the card on a separate moving or motorised stand. The greetings card/article is simpler, more compact and more economic to manufacture than that of U.S. Pat. No. 6,843,009 and provides an alternative new style of product.

### BRIEF DESCRIPTION OF THE DRAWINGS

Preferred embodiments of the present invention will now be more particularly described with reference to the following drawings, wherein:

FIG. 1 is a plan view of a sheet for forming the greetings card/display article of the first preferred embodiment, the sheet/article being shown substantially in an initial flat state;

FIG. 2 is a perspective view from above of the top side of the sheet of FIG. 1 in the process of being folded and manipulated into its operative configuration;

FIG. 3 is a perspective view from above of the sheet of FIG. 1 fully folded and assembled into the operative self-supporting greetings card/display article form, where part of the sheet forms an arcuate base and with the display card portion of the article extending upright therefrom;

FIG. 4 is a frontal perspective view of the assembled article from above;

FIG. 5 is a side elevation view of the assembled article;

FIG. 6 is a rear perspective view of the assembled article from below;

FIG. 7 is a plan view of a sheet for forming the greetings card/display article of a second preferred embodiment, the sheet/article being shown in a condition close to its initial flat state;

FIG. 8 is a frontal perspective view of the FIG. 7 article from below;

FIG. 9 is a frontal perspective view corresponding to FIG. 8 but of the article in its assembled operative configuration;

FIG. 10 is a top plan view of the assembled second embodiment article;

FIG. 11 is a frontal perspective view of a variant of the first embodiment of the article;

FIG. 12 is a frontal perspective view of a further variant of the first embodiment;

FIG. 13 is a perspective view of a two sheet construction third embodiment, as viewed from below to one side;

FIG. 14 is a perspective view of a second variant of the third embodiment, as viewed from below to one side;

FIG. 15 is a plan view of a base sheet for forming the article of the third embodiment, the sheet being shown in its initial, flat state;

FIGS. 16 and 17 are, respectively, a plan view of a first variant of an upstand sheet for forming the third embodiment, the sheet being shown in its initial flat state, and a corresponding plan view of a second variant of upstand sheet;

FIG. 18 is a perspective view of the upstand sheet of the first variant of the third embodiment, as viewed from above to one side, with the sheet part-way through being folded to bring the central zone of the upstand sheet into its upstanding configuration;

FIG. 19 is a perspective view of the base sheet of the third embodiment, as viewed from above to one side, showing the paired opposing arcuate base portions folded downwardly for use;

FIGS. 20 and 21 are, respectively, a perspective view of the third embodiment, as viewed from above to one side, in an initial stage of assembly of the base sheet to the upstand sheet and a corresponding perspective view in a final stage of assembly;

FIGS. 22 and 23 are, respectively, a plan view of a base sheet for forming a further variant of the third embodiment, the sheet being shown in its initial, flat state and a plan view of a corresponding upstand sheet;

FIGS. 24 to 27 are perspective views of the third embodiment further variant showing the final stages of assembly to the finally assembled state; and

FIG. 28 is an end elevation view of a further embodiment in the finally assembled erected state.

### DESCRIPTION OF THE PREFERRED EMBODIMENTS

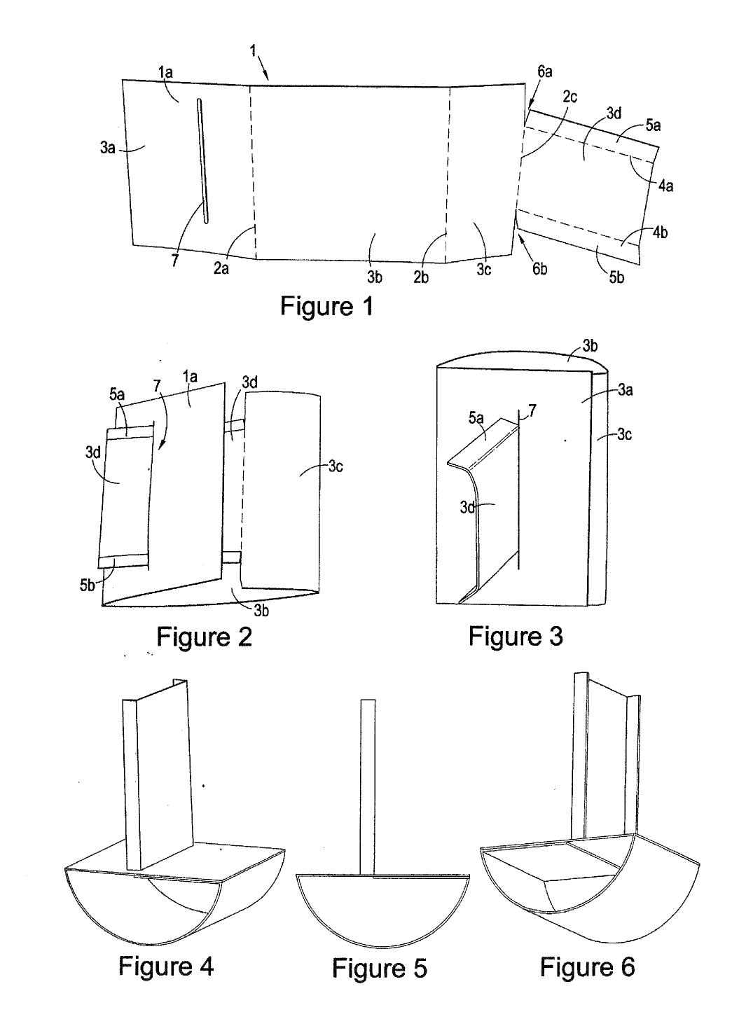

Referring to FIGS. 1 to 6, in the first preferred embodiment the display article is formed from a sheet of lenticulated plastics or lenticulated plastics-laminated card and bearing two or more interlaced images viewable from the lenticulated side 1a of the sheet 1. Here a generally rectangular sheet 1 has been cut, eg die-cut or laser-cut, to give it the outline shown in FIG. 1.

Fold lines are pre-scored into the plastics sheet 1 by any of a number of different methods, optionally including use of laser or heated wire or by mechanical incision/scoring with or without simultaneous heating of the plastics substrate. The fold lines may also be formed by folding the sheet 1 and cutting a series of intermittent cuts along the length of the fold, much like a dashed line, to facilitate subsequent folding. A number of slits are also made in the sheet the purpose of which will be explained below.

As can be seen in FIG. 1, the flat sheet 1 forming the display article has three transverse fold lines 2a, 2b, 2c dividing it into four longitudinal sections/panels 3a-3d. In FIG. 1 the fourth panel 3d is less wide than the first to third panels 3a-3c, which are generally all of the same width as each other.

The fourth panel 3d is provided with longitudinal fold lines 4a, 4b down its lateral margins, thereby forming narrow side flaps/sub-panels 5a, 5b. A neck slit 6a, 6b is cut at each side of the fourth panel 3d and extends partway along the fold-line 2c, where the fourth panel 3d hinges to the adjacent third panel 3c. These neck slits 6a, 6b give the side flaps 5a, 5b freedom to be folded about their fold lines 4a, 4b.

A transverse slit or slot 7 is provided extending across the middle area of the first panel 3a and is of a width and positioned to allow the narrower fourth panel 3d to be fed through it when folding the sheet about the transverse fold lines 2a, 2b, 2c to form the article into its operative state. When the fourth panel 3d is fed through the transverse slot 7 the side flaps 5a, 5b then come into play by, when folded out of co-planarity with the fourth panel 3d, acting to lock the fourth panel 3d in place projected through the slot 7, preventing it from slipping back through the slot 7 and thus holding the display article in its operative configuration.

The narrow fourth panel 3d with its side flaps 5a, 5b is the portion of the article that is the upright/upstanding display card portion of the greetings card/display article in use. The other three panels 3a-3c fold together to provide the base structure for the article. Referring to FIG. 2, the panels 3a-3c are brought together with the first 3a and third panel 3c part over-so lapping. They are inter-locked by insertion of the fourth panel 3d through the slot 7 and in this position the intermediate second panel 3a is pulled into a bowed/arcuate profiled state. Secured in this bowed state the intermediate second panel 3a provides the greetings card/display article with an arcuate base for rocking back and forth.

The side flaps 5a, 5b serve not only for locking the display panel/fourth panel 3d in place and locking the second panel 3b in the bowed state but also, being angled rearwardly help to provide additional weight to the rear of the greetings card/display article to counter-balance the weight of the excess card at the front of the greetings card/display article that is there to allow for the folding assembly.

By providing the greetings card/display article with this integral arcuate base for rocking, the article is able to be stood on a shelf, table or other substantially horizontal surface and gently tapped to start executing a rocking motion. No external rocker, pendulum or motor is required to give the article movement and yet the article is able to rock and the images on the article that are covered by the lenticulated layer are animated before the user's eyes.

Although the card/display article may be supplied in the form shown in FIG. 1 it may also be supplied pre-assembled but flat, if desired.

As explained earlier, the display article may serve a variety of roles but in one example it may serve as a toy. As such this may take advantage of the fact that it may rock back-and-forth but may also take advantage of the fact that the bowed base enables it to be made to bounce and flip when depressed from one side. This feature could even have use in a game and coupled with markings on the article and variations in the way that it jumps and falls could be used like a random number generator or other game-play determinator. in a board game or any other game. Additionally, by varying the radius of curvature and other proportions of the greetings card/display article it's rocking behaviour may be adjusted, oscillating faster or slower or for more or less cycles before coming to rest. This may also be used as part of game-play techniques. For example, one rocking card may ‘battle’ against another based on a particular chosen one of the preceding attributes, or other attributes, of the rocking cards. The article may even be varied to form the body of a distinct character and children may, for example, be able to clip on or otherwise attach plastic or card etc ears, eyes, legs or other features/appendages to differentiate the character and vary its wobble.

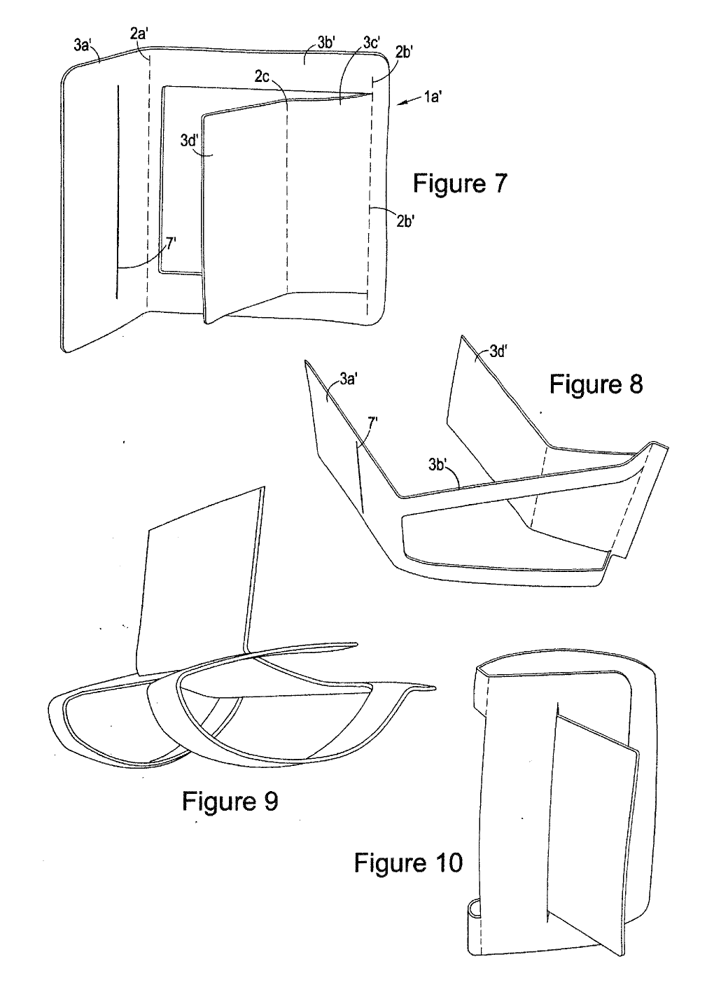

Referring to FIGS. 7 to 10, these show a variant of the greetings card/display article that has a somewhat different arrangement of fold lines and panel configuration. Here the sheet 1′ has similar first to fourth panels 3a′-3d′, defined by fold-lines/score-lines 2a′-2c′, but the third and fourth panels 3c′ and 3d′ are cut from the central region of the second panel 3b′ such that the second panel 3b′ is no more than a pair of lateral strips and which provide the rocker base to the greetings card/display article. Again the second panel 3b′ is bowed to allow the fourth panel 3d′ to be inserted through the slot 7′ of the first panel 3a′.

In a further variant of the construction of the article it may have the form of a plastics/card sheet but which is integrally assembled rather than integrally formed, being made of a series of discrete panels 3a-d that are mounted on a web or linked by hinges that may be of other material or of a different thickness. This may apply to any of the embodiments of the invention

As a refinement that may be adopted for some embodiments and which may be particularly suitable for larger sizes of card/display article, a weight may be added to the lower part or base structure of the card/display article to lower the centre of gravity. This may allow for a proportionately larger upright display panel 3d and smaller curvature of the base 3b. In one such example the top edge of the upright display panel 3d may be extended to fold back over and extend back down the panel 3d, extending down so it hangs in the middle of the arcuate cavity of the base 3d. A weight may be crimped or otherwise attached to the lower end of this down-hanging extension.

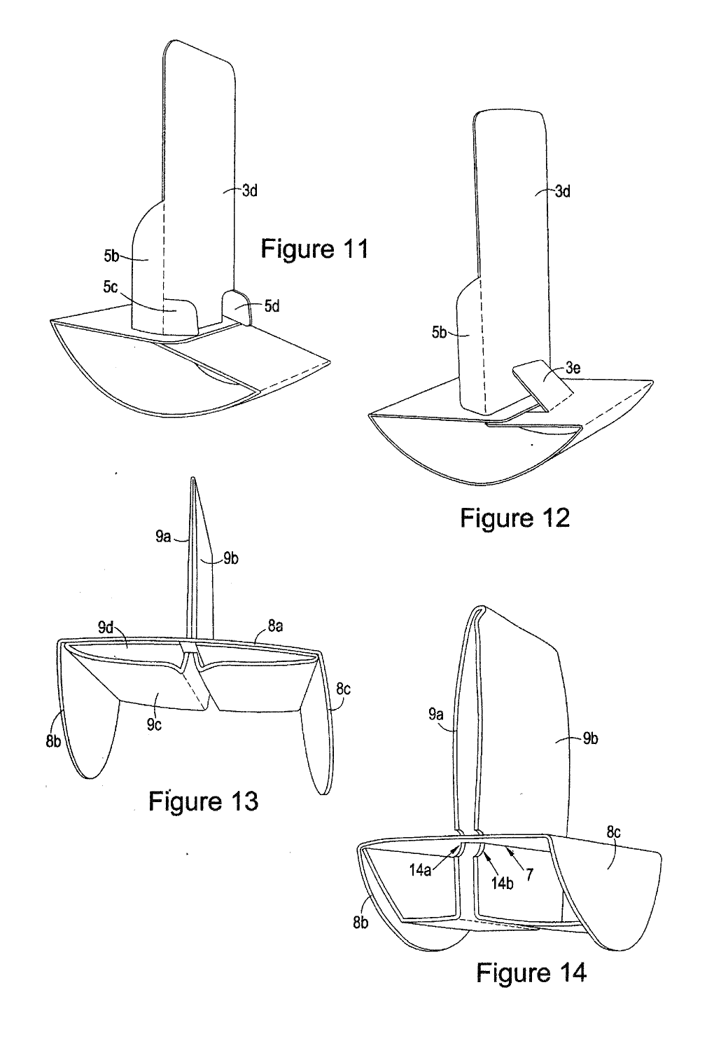

Referring to FIG. 11, this shows a variant of the first embodiment having a respective one of a pair of forward projecting stabiliser tabs 5c, 5d at the lower end of each of the side flaps 5a, 5b of the upright panel 3d. These stabiliser tabs 5c, 5d are illustrated as being simple forwardly folded cut-outs from the upright panel 3d and they may press down against the leading edge of the first panel 3a providing extra support/restraint to the upright panel 3d from the front.

FIG. 12 shows a further variant of the first embodiment, having a rearward projecting central stabiliser tab 3e on the first panel 3a just forward of the upright panel 3d. This stabiliser tab 3e is illustrated as being a simple rearwardly upwardly folded cut-out from the first panel 3a and it may serve to press against the front face of the upright panel 3d providing extra support/restraint to the upright panel 3d from the front.

FIG. 13 shows a third embodiment of the greetings card/display article, which is preferably formed of plastics sheets, though may be made of card. Unlike the previous two embodiments, in this the upstanding display panel lies primarily in a plane that is aligned with the axis/plane of rocking movement so that there is minimal air resistance from the display panel on the rocking movement. Where the sheet of the upstanding display panel is lenticular the lenticules may be arranged vertically or at least more vertically than horizontally to reduce drag further.

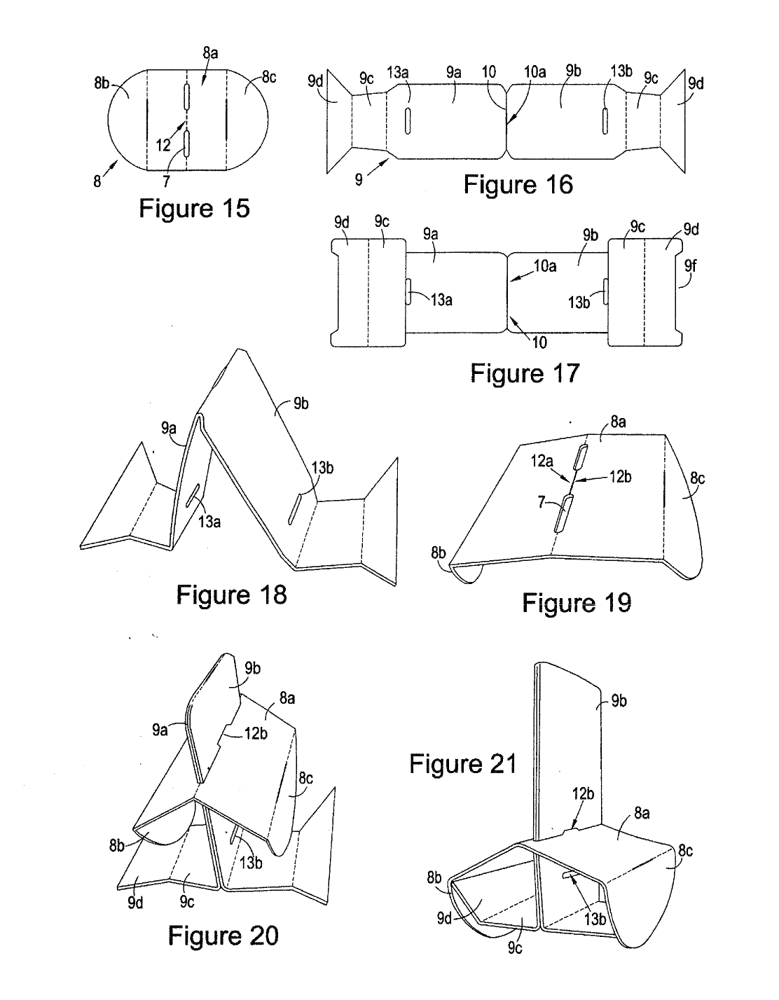

Furthermore, the third embodiment differs in that it is a two sheet construction with a first sheet, which we shall refer to as the base sheet 8, the end panels 8b, 8c of which fold downwardly from the flat state shown in FIG. 15 to bring the base into the erected state shown in FIG. 19. This defines the base of the article with a central bridging panel 8a between a pair of mutually parallel semi-circular/rounded/arcuate panels 8b, 8c for rocking.

The second sheet, which we shall refer to as the upstand sheet 9, folds from the flat state shown in FIG. 17 to provide a sturdy double-thickness upstanding panel 9a, 9b shown in FIG. 13. In FIG. 13 the two central portions 9a, 9b of the upstand sheet 9 are brought into back-to-back arrangement by folding about a fold-line 10 between them and made to protrude up through a central slot 7 in the central bridging panel 8a of base sheet 8. Ease of folding about the fold line 10 may be facilitated by a short slit 10a in the central bridging panel along the fold line 10.

The central slot 7 in the central bridging panel runs along a transverse axis 11 that is at the centre of the central bridging panel 8a and centre of the upstand sheet 8. The base sheet 8 is symmetrical about the transverse axis 11. The slot 7 is approximately the same width as the thickness of the double-thickness upstanding panel 9a, 9b and is of a length to accommodate the width of the upstanding panel 9a, 9b. A pair of securing tabs 12a, 12b project from the rim of the slot 7 towards each other across the slot 7 and substantially touch at the transverse axis 11 at the centre of the slot 7. These tabs 12a, 12b are each arranged to latch into a respective slot/socket 13a, 13b near the base of the back-to-back portions 9a, 9b of the upstanding panel to ‘lock’ the upstanding panel in place when the upstanding panel protrudes the correct height up through the slot 7 and the central bridging panel 8a is substantially level (not arching or part-down-folded about the transverse axis 11 as it often is when initially assembling the upstand sheet 9 to the base sheet 8).

The upstand sheet 9 illustrated in FIG. 19 is symmetrical about its central fold line 10 and at each end flanking the upstanding panels 9a, 9b it has a respective intermediate basal panel 9c and terminal basal panel 9d joined to each other or to the respective upstanding panels 9a, 9b at fold lines. These basal panels 9c, 9d anchor the upstand sheet 9 to the base sheet 8 and provide extra strength and weight to the rocking base of the article.

The intermediate basal panel 9c is folded about the fold line that links it to the adjacent upstanding panel 9a, 9b so that it extends substantially horizontally in use and the terminal panel 9d is in turn folded back-to-back against this intermediate basal panel 9c. The upper surface of each terminal panel 9d is adhered to the underside of the respective part of the central bridging panel 8a of the base sheet to left and right of the central fold line 10 and upstand. It will be noted that each terminal panel 9d is shaped at the end with a shallow recess 9f to embrace the upstanding panel 9a, 9b.

Referring to FIG. 14, this shows a second variant of the third embodiment. This differs from the first variant firstly in that it is constructed using the upstand sheet 9 illustrated in FIG. 16 and secondly in that instead of the pair of securing tabs 12a, 12b and co-operating sockets 13a, 13b there are pairs of basal notches 14a, 14b in each side edge of the upstanding panels 9a, 9b. These serve the same function as the securing tabs 12a, 12b and engage the central bridging panel 8a because the slot 7 is slightly less wide than the width of the upstanding panels 9a, 9b which must be flexed to pull them through the slot 7.

The upstand sheet 9 illustrated in FIG. 16 differs from the upstand sheet 9 of FIG. 17 primarily in the shape of the intermediate basal panel 9c and terminal panel 9d. These are shaped to mount the upstand sheet 9 to the base sheet 8 at a lower level on the base, to further lower the centre of gravity of the article and increase rigidity/sturdiness of the article. The terminal basal panels 9d fold perpendicular to the intermediate basal panels 9c and thus project upright and are adhered to the base sheet end panels 8b, 8c, not to the underside of the base sheet's central bridging panel 8a.

The variant of the third embodiment shown in FIGS. 18 to 21 differs from the FIG. 14 embodiment simply in that it reverts to the use of the securing tabs 12a, 12b and co-operating sockets 13a, 13b rather than the less effective basal notches 14a, 14b.

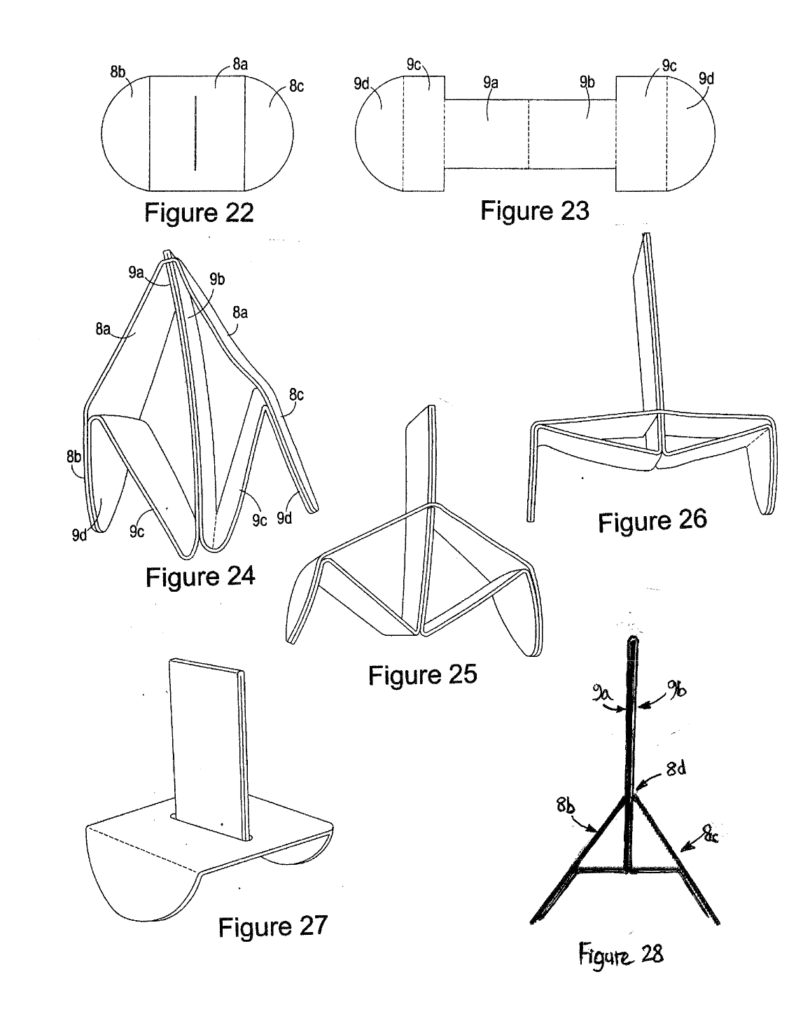

Referring to FIGS. 22 to 27, these show a further simpler/less sophisticated variant of the third embodiment that lacks securing tabs or notches and wherein the terminal basal panels 9d of the fold perpendicular to the intermediate basal panels 9c but project downwardly and are adhered to the base sheet end panels 8b, 8c. Accordingly in this variant the centre of gravity is not lowered. Nevertheless, it too is a flat pack item, as supplied, where the adhered panels 9d of the upstand sheet 9 and base sheet 8 arcuate can have been glued together in manufacturing and the article can be easily pushed up to the erected rocking state by a child for use.

The arrangement of the basal panels 9c, 9d in FIGS. 14 and 21 slung low underneath the base as a lower platform and adhered, suitably by the terminal basal panels 9d, to the inside face of the arcuate walls/rockers 8b has a further advantage over the FIG. 27 variant in that it more reliably positions and holds the arcuate walls/rockers 8b where they need to be, plane parallel and substantially vertical, in the erected state.

Whereas the preferred embodiments have the graphic or text images printed, or otherwise provided, solely or primarily on the upright display panel/card portion, there may be text or graphic images on other parts of the article including the panels that comprise the base structure and not only on the outer in use faces of those panels but also their reverse faces. For the latter there may, for example, be text information explaining folding assembly or there may be advertising text or graphic images. Any or, most simply, all of these may be covered with a lenticular layer or integrally formed of lenticular sheet and may be of interlaced image type taking advantage of the lenticular layer or alternatively the inter-laced images may be concentrated on the upright display panel/card portion.

The rocking base's base portion may be a substantially flat, level stage-like platform between the rockers when the device is in the fully assembled/erected state such as, for example, shown in FIGS. 26 and 27 or it may be a narrow platform comprising a summit or ridge where a pair of rockers are joined together such as shown in FIG. 28. In the case of FIG. 28, this is similar to FIG. 25 but here the device is in the fully erected state and the arcuate walls/rockers 8b, 8c are not plane parallel to each other but are instead inclined to each other, splaying apart from the summit 8d where the pair of arcuate walls/rockers 8b, 8c join together.

1. A greetings card or other flat pack folding sheet self-supporting display article that comprises: at least one sheet that is flat in an initial state but when folded to its operational configuration defines a rocking base that has a base portion supported by at least one rocker and the article having an upstanding card portion or panel serving as a display panel bearing text or graphic images that extends upright from the rocker-supported base portion and wherein the rocker-supported base portion of the rocking base has an aperture therein up through which the upstanding display panel is projected and extends upwardly.

2. A greetings card or display article as claimed in claim 1, wherein the at least one rocker of the base of the card/article on which the card stands in use is arcuate/curved in profile to allow the card to rock back and forth.

3. A greetings card or display article as claimed in claim 1, wherein the aperture is a slot that constrains the upstanding display panel.

4. A greetings card or display article as claimed in claim 1, wherein the article is formed of at least two sheets, one of which defines the rocking base and the other of which defines the upstanding display panel.

5. A greetings card or display article as claimed in claim 2, wherein there are two rockers of the base portion of the card/article on which the card stands, each being formed at a respective opposing end of a said sheet as a curved end of the sheet.

6. A greetings card or display article as claimed in claim 1, wherein it further comprises interlaced images and a lenticular layer covering the image-bearing part of the upstanding card portion, or the image of the image-bearing part is a hologram, whereby when the card/article is induced to rock back and forth on its arcuate base portion the image will change.

7. A greetings card or display article as claimed in claim 1, wherein fold lines are pre-scored/formed into the sheet for assembly to the operational configuration.

8. A greetings card or display article as claimed in claim 1, wherein a number of slits are provided in the sheet to facilitate assembly to the operational configuration.

9. A greetings card or display article as claimed in claim 1, wherein the at least one sheet forming the greetings card/display article has transverse fold lines dividing it into longitudinal sections/panels.

10. A greetings card or display article as claimed in claim 1, wherein the upstanding display panel is provided with longitudinal fold lines down its lateral margins, thereby forming narrow side flaps/sub-panels.

11. A greetings card or display article as claimed in claim 1, wherein the rocker-supported base portion comprises a substantially flat, level stage-like platform between a pair of rockers.

12. A greetings card or display article as claimed in claim 11, wherein folds/portions of the upstand sheet below the platform are adhered to the underside of the platform.

13. A greetings card or display article as claimed in 1, wherein folds/portions of the upstand sheet below the rocker-supported base portion are adhered to the inside walls of the base portion.

14. A greetings card or display article as claimed in claim 1, wherein the upstand sheet, is folded from a flat state to be doubled up to provide a sturdy double-thickness display panel.

15. A greetings card or display article as claimed in claim 1, wherein at least one securing tab projects from the rim of the aperture across the aperture to latch into a socket near the base of the upstanding display panel.

16. A greetings card or display article as claimed in claim 1, wherein the device has opposing walls that define rockers and when the device is in the fully erected state the walls are not plane parallel to each other but are instead inclined to each other, splaying apart from a summit where the walls join together

17. A greetings card or display article as claimed in claim 1, wherein the upstanding display panel lies primarily in a plane that is aligned with the axis/plane of rocking movement so that there is minimal air resistance from the display panel on the rocking movement.

18. A greetings card or display article as claimed in claim 1, wherein part of the base of the display panel that lies below the rocker-supported base portion in use serves as a lower platform and positions and holds the arcuate walls/rockers apart in the erected state of the article.

19. A greetings card or display article as claimed in claim 1, as part of game-playing apparatus having a range of different attachments to have differing rocking performance including speeding up or slowing down the rate of rocking.

20. A greetings card or display article as claimed in claim 1, wherein the flat-pack card or display article assembles from the flat pack state to the erected rocking state by pulling the upright outwardly from within another part of the article in which it is at least partly initially concealed.

21. A greetings card or display article as claimed in claim 4, supplied with the at least two sheets pre-glued together or provided with at least one adhesive tab covered by a release strip (or similar) on a part to be adhered to another part.
